(19) United States
(12) Patent Application Publication
(10) Pub. No.: US 2003/0136236 A1
(43) Pub. Date: Jul. 24, 2003

(54) Handle for a two-limbed tool

(76) Inventors: Andreas Dierolf, Untermuenkheim (DE); Karl Lieser, Wuppertal (DE)

Correspondence Address: Michael J McGovern, Quarles & Brady, 411 E Wisconsin Ave, Milwaukee, WI, 53202-4497, US

(21) Appl. No.: 10/220,749

(22) PCT Filed: Feb. 24, 2001
(86) PCT No.: PCT/EP01/02103

(30) Foreign Application Priority Data
Mar. 4, 2000 (DE) 100 10 674.9

(51) Int. Cl. B25B 7/00

(52) U.S. Cl. 81/427.5

(57) ABSTRACT

Pliers contain on both pliers limbs a pliers handle, which is injection moulded round the corresponding metal pliers limbs. Injection moulding on takes place at a point located at the handle end facing the pliers joint. As a result the entire surface of the handle, which can be gripped by a user, remains free from surface disturbances and interference. A raised marking can be applied to the mould-on point.

It is known in the case of certain pliers, which are made from metal, to provide the handles with a covering made from plastic in order to facilitate the handling of the pliers.

In the case of known pliers of this type (FR-A-2215294), the handle shell is manufactured as a separate plastic component, which is separately engaged on and joined to the limbs of the pliers.

In a further pliers-like hand tool (DE 30 19 734 A1), following manufacture the handle shell is drawn onto the handle limbs.

Pliers are also known in which the handles are injection moulded from a relatively rigid plastics material.

The problem of the invention is to ergonomically further develop a handle for a two-limbed tool.

To solve this problem the invention proposes a handle having the features of claim 1 and/or the features of claim 2. Further developments of the invention form the subject matter of the dependent claims, whose wording, like that of the abstract, is by reference made into part of the content of the description.

Pliers are used for various purposes. They are not only used for holding articles, but also for moving, reorienting or also carrying the held articles. Whereas in the case of the known pliers handles, which are injection moulded from plastic, the mould-on point is located at the free end of the handle, said points are now displaced to the opposite ends of the handles. If a user shoves with the pliers, then the end of the pliers can engage on the ball of his thumb or the palm of his hand. Due to the fact that the mould-on point is no longer at the indicated location, there is a significant improvement to the use of the pliers.

Handling is also improved by the construction of the outside of the handles with a softer surface. The somewhat softer surface improves both the grip and the compressive load application of the hand.

As stated here using the example of pliers, applies in the same or similar manner for other two-limbed tools, e.g. shears. Particularly in the case of plate, carpet or pruning shears it is frequently necessary to apply high forces. Here again it is appropriate to implement the features proposed by the invention.

According to a further development of the invention, the inside of the handle facing the in each case other handle has a harder surface than the area with the softer surface. The user grips on these points in order to open the tool and consequently a lower force is involved, so that here a softer surface leads to no particular advantages.

According to a further development of the invention, the areas with different surface hardness can also have different colours.

According to the invention it can be adequate to provide the area with the softer surface only on the handle parts where the hand of the user is particularly loaded. However, according to the invention, it is advantageously possible for the area with the softer surface to extend in the longitudinal direction of the handle from the end associated with the joint up to the free end of the handle. The handle end associated with the joint can e.g. have a cross-sectional widening clearly marking the end of the handle part gripped by the user, even if the plastic pliers limb part around which injection moulding has taken place extends somewhat further. This widening generally serves to prevent slipping or sliding and is frequently referred to as the handle head.

It is also possible for the area with the softer surface to at least partly include the flat sides of the handle.

The areas with the different surface hardness can be manufactured in that a coating made from softer material is applied in a second operation to the handle area to have the lower surface hardness. The coating can be relatively thin.

According to a further development of the invention, the mould-on point, which even with the most careful working always remains visible, is used for applying a marking, which can in particular be a raised marking. This can be used for indicating the nature of the pliers, the manufacturer, etc. It is in particular constructed in such a way that it is not destroyed even after prolonged use of the pliers, as would be the case if printed on.

According to a further development, the handle of the two-limbed tool can have a marking in the softer surface area, which is formed in that at this location parts of the core of the handle made from harder or more rigid material remain as raised parts around which is injection moulded the softer material. The surface of said raised parts is flush with the softer surface. As a result there is a permanent marking maintained even after prolonged tool use.

According to a further development of the invention, the coating with the softer material takes place by injection moulding on of the handle end associated with the joint and preferably this takes place through a gap in the handle head. This gap can e.g. be located at the outside of the corresponding handle limb remote from the in each case other handle. Normally a user does not grip at this point, so that said gap, which is then filled by the softer material, does not have a damaging or interfering effect. It is in particular located on the flat sides of the pliers.

According to the invention onto the handle end associated with the joint is injection moulded a marking, which can be raised or depressed.

Further features, details and advantages of the invention can be gathered from the following description of a preferred embodiment and with reference to the attached drawings, wherein show:

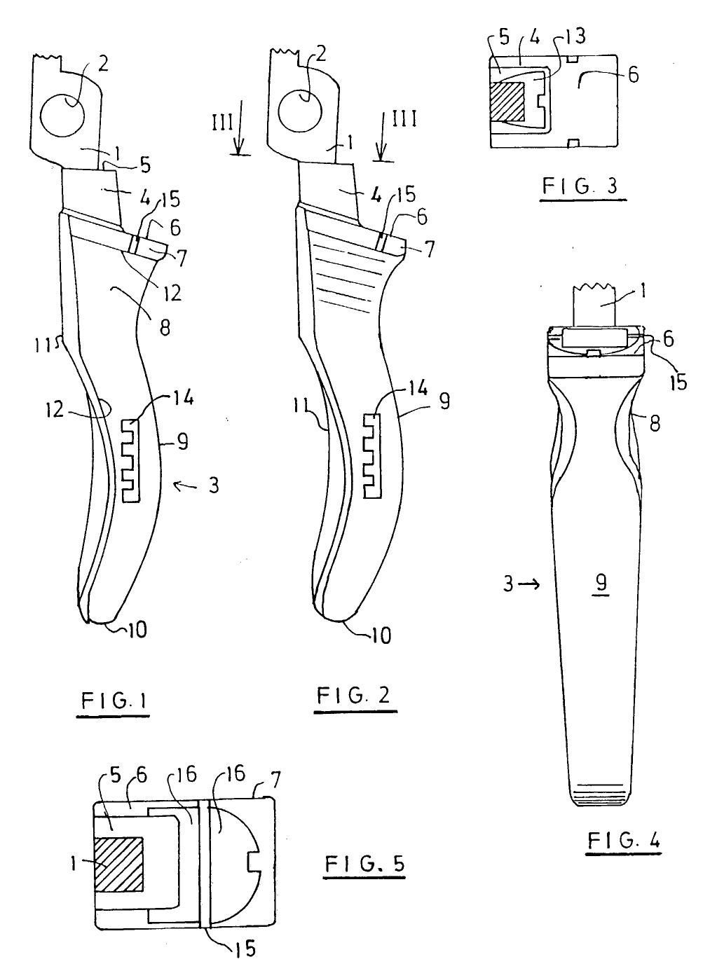

FIG. 1 A diagrammatic side view of a handle injection moulded around a pliers limb following a first working step.

FIG. 2 The same view after a further working step.

FIG. 3 A section along line III-III in FIG. 2.

FIG. 4 A view of the handle limb from the right in FIGS. 1 and 2.

FIG. 5 A larger scale section corresponding to FIG. 3 of a modified embodiment.

In the drawings pliers are used as an example of a two-limbed tool. All that is said here in connection with the handle of pliers, also applies to other two-limbed tools, such as e.g. plate shears and the like.

The side view of FIG. 1 shows in broken away form a pliers limb, e.g. a pliers limb of combination pliers. The pliers limb 1 has a hole 2, which when the pliers are assembled receives a shaft for forming the pliers joint. The plastic handle 3 is injection moulded almost up to said opening or hole 2. Starting from the pliers joint there is initially a first shoulder 4, which is roughly shaped like a parallelepiped. This shoulder 4 has a planar end face 5, cf. FIG. 3, surrounding the metal pliers limb 1.

To the first shoulder 4 is connected a planar, sloping surface 6, which is at an angle of approximately 15° to the longitudinal axis of the closed pliers. The sloping surface 6 forms the boundary of a slipping or sliding preventer 7. To the slide protection is connected a handle area 8, which is concave and serves to receive the thumb and on the opposite side the index finger of the user. In the connecting part the outside 9 of the handle is curved. The handle then ends in the rounded, free end 10.

The inside 11 of the handle is the side which, when the pliers are assembled, faces the hand application and is the left-hand side in FIGS. 1 and 2.

FIG. 1 shows the pliers handle in the way which it appears following the injection moulding process. At the transition between the inside 11 and the top flat side of the handle in FIGS. 1 and 2 is formed an edge 12, which represents a step. This step can best be seen at the bottom of FIG. 1. The step 12 is also constructed on the side of the sliding preventer 7 remote from the pliers joint. On the flat side faces of the handle limb 3 shown in FIG. 2 one part is constructed as a raised marking 14. On the edges of said marking 14 are also formed steps, which have the same height as the edges 12. Said marking 14 can be a designation of the pliers and optionally an indication of the manufacturer of the pliers.

Subsequently the area of the handle 3 located between the step 12 of the inside 11 and the step 12 of the sliding preventer 7 is lined with a softer material in a second working step, e.g. once again in an injection moulding process. For this purpose the handle is placed in a mould into which the material is injected. As a result the area between the steps 12 is filled, so that the handle shape shown in FIG. 2 is obtained. In the vicinity of its outside, i.e. to the right in FIG. 2 and in the vicinity of its two flat sides, the handle 3 is provided with a surface softer than the surface of the inside 11.

During injection moulding, moulding on takes place at surface 5 or surface 6, i.e. at the end of the handle associated with or facing the pliers joint. As a result the entire surface of the handle which can be gripped by a user remains free from a mould-on point.

FIG. 3 shows in a section along line III-III of FIG. 2 the front view of the handle end associated with the pliers joint. On the outer end face 5 where moulding on takes place, a marking 13 has been produced during moulding on and can be constructed e.g. as a raised marking, but also as a depressed marking. This is not a printed on marking, but a marking in the actual handle material and which is consequently durable.

FIG. 4 is a view of the pliers handle from the outside, i.e. from the right in FIG. 1. The edge of the sliding preventer 7 contains a gap 15 on either side through which takes place the moulding on of the surface area of the handle limb. The material to form the softer surface is injection moulded through this gap 15 and fills the space between the hard part of the handle and the mould. The material also flows round the marking 14, so that it is then flush with the surface of the softer material.

During moulding on, which in this case does not take place from the upper surface 5, but instead from the surface 6, can allow a relief-like marking to be applied to said handle surface 6 and this is e.g. shown in FIG. 5. On the surface 6, which is larger than the surface 5, more space is available for such a marking.

1. Handle for a two-limbed tool, which
1.1 is arranged around one end of a tool limb (1),
1.2 which is injection moulded from plastic,
1.3 has a front end associated with the joint and
1.4 an opposite, free end (10), in which
1.5 the mould-on point is located on the end of the handle (3) remote from the joint.

2. Handle, particularly according to claim 1, which
2.1 is arranged around one end of a tool limb (1) and
2.2 is made from plastic, in which
2.3 the outside (9) of the handle (3) remote from the other tool limb at least in part has a softer surface than in the known handles.

3. Handle according to claim 1 or 2, wherein the inside (11) of the handle (3) facing the in each case other handle has a harder surface than the area with the softer surface.

4. Handle according to one of the preceding claims, wherein areas of different surface hardness have different colours.

5. Handle according to one of the preceding claims, wherein the area with the softer surface in the longitudinal direction of the handle (3) extends from the handle end facing the joint to the free end (10) of the handle (3).

6. Handle according to one of the preceding claims, wherein the area with the softer surface at least partly also includes the flat sides of the handle (3).

7. Handle according to one of the preceding claims, wherein the softer surface is produced by coating the handle with a softer material.

8. Handle according to one of the preceding claims, with at least one marking (14) in the surface area with the softer surface and which is formed by raised parts of the harder material core.

9. Handle according to one of the preceding claims, wherein the coating with the softer material is provided by injection moulding or moulding on from the handle end associated with the joint.

10. Handle according to claim 9, wherein injection moulding on takes place through a gap (15) in the outside of the handle head (7).

11. Handle according to one of the preceding claims, wherein a marking (13, 16) is injection moulded onto the end of the handle (3) associated with the joint.
